(19) United States
(12) Patent Application Publication
(10) Pub. No.: US 2007/0208618 A1
(43) Pub. Date: Sep. 6, 2007

(54) COUPON CODE SYSTEMS AND METHODS

(75) Inventors: Scott R. Paintin, Littleton, CO (US); Rieley K. Scott, Centennial, CO (US); Michael J. Hafer, Highlands Ranch, CO (US); Paul Jost, Denver, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: First Data Corporation, Greenwood Village, CO (US); The Western Union Company, Englewood, CO (US)

(21) Appl. No.: 11/535,353

(22) Filed: Sep. 26, 2006

Related U.S. Application Data
(60) Provisional application No. 60/779,907, filed on Mar. 6, 2006.

(51) Int. Cl. G06Q 30/00

(52) U.S. Cl. 705/14

(57) ABSTRACT

A method for providing a coupon code to a recipient via a network includes storing a coupon code on a tangible storage medium of a host computer, receiving a request for the coupon code from the recipient, and providing the recipient with the coupon code via the network in response to the request. The coupon code is transmitted along the network between the host computer and the recipient as an analog or digital audio signal.

### CROSS-REFERENCES TO RELATED APPLICATIONS

This application claims the benefit of U.S. Provisional Patent Application No. 60/779,907, filed Mar. 6, 2006, the entire contents of which are hereby incorporated by reference for all purposes.

### BACKGROUND OF THE INVENTION

The present invention generally relates to marketing systems and methods. More particularly, embodiments of the present invention relate to coupon code systems and methods for discounting money transfer fees.

Coupon codes, which encompass promotional codes and discount codes, are commonly used in financial transactions. For example, popular online retailers such as Amazon.com Inc. often provide an electronic shopping cart that includes a designated field for entering a coupon code. Upon entry of the coupon code, a customer may receive a discount on their purchase. The discount can be, for example, a dollar amount or a percentage of a purchase price.

Coupon codes are effective marketing tools, and many consumers are attracted by the savings and other opportunities made possible with these codes. Accordingly, retailers and other entities are continually seeking improved techniques for providing and using coupon codes. Yet many known coupon codes may not be well suited for efficient distribution to customers and other recipients. Relatedly, some current coupon codes are limited in their ability to generate useful marketing information for coupon issuers and others who may find value in such data. For these and other reasons, there remains a need for better approaches for delivering coupon codes to recipients in a convenient manner that can generate useful marketing data.

### BRIEF SUMMARY OF THE INVENTION

The instant invention addresses these and other unfulfilled needs by providing systems, devices, and methods for coupon codes, promotional codes, and discount codes that can be used to discount money transfer fees and other financial services transactions and communication transactions, to obtain discount purchases or other products and services, to provide premium items, to enter contests or sweepstakes, or to obtain other benefits. Such coupon codes can offer convenience and savings to customers. Moreover, the data generated by the retrieval and redemption of the coupon codes can be used to develop or revise marketing strategies to more effectively provide consumers with targeted products and services. In addition, coupon codes of the present invention can effectively establish or enhance a tangible connection between a business and a consumer. Each time a coupon code is used, a business brand can be communicated, an image can be projected, and customer loyalty can be strengthened.

Advantageously, the present invention provides coupon codes, promotional codes, and discount codes that can be used in conjunction with a wide variety of products and services, for example to provide discounts or premium items or to enter contests or sweepstakes. In some cases, coupon codes may be used for financial and communication products and services offered by companies such as Western Union Financial Services, Inc. These products and services include money transfers such as Western Union Money Transfer® transactions, money orders, telegrams, and prepaid products or services such as prepaid wireless phone services, prepaid home phone services, prepaid long distance cards, and the like. For example, to transfer money, a transferor may visit or contact a money transfer agent location of a distributed network of locations, and submit a money transfer request that includes a transferee's name, the amount to be transferred, or any other required information. Typically, the transferor will pay a transfer fee for the money transfer. Among other things, the present invention provides a coupon code that may be used by the transferor to discount the transfer fee. The transferee then visits a money transfer location associated with the network of locations, provides the appropriate identification, and receives the transferred money.

In one aspect, embodiments of the present invention provide a method for providing a coupon code to a recipient via a network. The method can include storing a coupon code on a tangible storage medium of a host computer, receiving a request for the coupon code from the recipient, and providing the recipient with the coupon code via the network in response to the request. The coupon code can be transmitted along the network between the host computer and the recipient as an analog or digital audio signal. In some embodiments, the network includes a telephone network. In some embodiments, the coupon code corresponds to a discount for a money transfer fee. The coupon code can include, for example, a redemption limit identifier that limits the number of times the coupon code may be used, a redemption location identifier that designates a redemption location at which the coupon code may be redeemed, or a redemption expiration date that indicates a date beyond which the coupon code is irredeemable. In some cases, the coupon code corresponds to a discount based on an Automatic Number Identification (ANI) associated with the recipient's request. In some cases, the coupon code corresponds to a discount based on a usage log compiled for an Automatic Number Identification (ANI) associated with the recipient's request. The method can also include providing the recipient with instructions for redeeming the coupon code. The instructions can be based on an Automatic Number Identification (ANI) associated with the recipient's request. In some cases, the coupon code corresponds to a discount based on a loyalty code provided by the recipient.

In another aspect, embodiments of the present invention encompass a system for providing a coupon code to a recipient via a telephone network. The system can include a tangible storage medium that stores a coupon code, an input module that receives a request for the coupon code from the recipient, and an output module that transmits the coupon code from the tangible storage medium to a network in response to the recipient request, such that the coupon code is configured for delivery along the network toward the recipient as an analog or digital audio signal. The output module can include an interactive voice response system. The coupon code can correspond to a discount for a money transfer fee. In some embodiments, the coupon code includes a redemption limit identifier that limits the number of times the coupon code may be used, a redemption location identifier that designates a redemption location at which the coupon code may be redeemed, or a redemption expiration date that indicates a date beyond which the coupon code is irredeemable. The coupon code can correspond to a discount based on an Automatic Number Identification (ANI) associated with the recipient's request.

In another aspect, embodiments of the present invention involve a system for providing a discount on a money transfer fee. The system can include a request module that receives a request to perform a money transfer, a fee module that calculates a money transfer fee for the money transfer, and a discount module that discounts the money transfer fee based on the coupon code. In some aspects, the coupon code can include a redemption limit identifier that limits the number of times the coupon code may be used, a redemption location identifier that designates a redemption location at which the coupon code may be redeemed, or a redemption expiration date that indicates a date beyond which the coupon code is irredeemable. The coupon code can correspond to a discount based on an Automatic Number Identification (ANI) associated with the recipient's request.

In some aspects, embodiments of the present invention encompass a method for providing a discount on a money transfer fee. Such methods may include providing a coupon code to a customer via a telephone network, receiving a request to perform a money transfer, receiving the coupon code, calculating a money transfer fee for the money transfer, and discounting the money transfer fee based on the coupon code. The coupon code can include a redemption limit identifier that limits the number of times the coupon code may be used, a redemption location identifier that designates a redemption location at which the coupon code may be redeemed, or a redemption expiration date that indicates a date beyond which the coupon code is irredeemable.

In one aspect, embodiments of the present invention provide a system for transferring money. The system can include a coupon code generation system configured to receive a coupon code request and transmit a coupon code to a recipient as an analog or digital audio signal in response to the coupon code request, and a coupon code redemption system configured to receive a money transfer request from a transferor and discount a money transfer fee based on the coupon code. The coupon code can include a redemption limit identifier that limits the number of times the coupon code may be used, a redemption location identifier that designates a redemption location at which the coupon code may be redeemed, or a redemption expiration date that indicates a date beyond which the coupon code is irredeemable.

For a fuller understanding of the nature and advantages of the present invention, reference should be had to the ensuing detailed description taken in conjunction with the accompanying drawings.

### BRIEF DESCRIPTION OF THE DRAWINGS

FIG. 1 illustrates an exemplary coupon code system according to embodiments of the present invention.

FIG. 2 shows an exemplary coupon code system according to embodiments of the present invention.

FIG. 3 depicts a money transfer discounting system according to embodiments of the present invention.

FIG. 4 illustrates a money transfer system according to embodiments of the present invention.

FIG. 5 illustrates a method of providing a coupon code to a recipient according to embodiments of the present invention

FIG. 6 shows a method of providing a coupon code to a recipient according to embodiments of the present invention.

FIG. 7 shows a method for providing a discount on a money transfer fee according to embodiments of the present invention.

FIG. 8 illustrates a method for transferring money according to embodiments of the present invention.

FIG. 9 depicts a promotional script for a coupon code system according to embodiments of the present invention.

FIG. 10 illustrates a method for processing a request for a coupon code based on a script according to embodiments of the present invention.

### DETAILED DESCRIPTION OF THE INVENTION

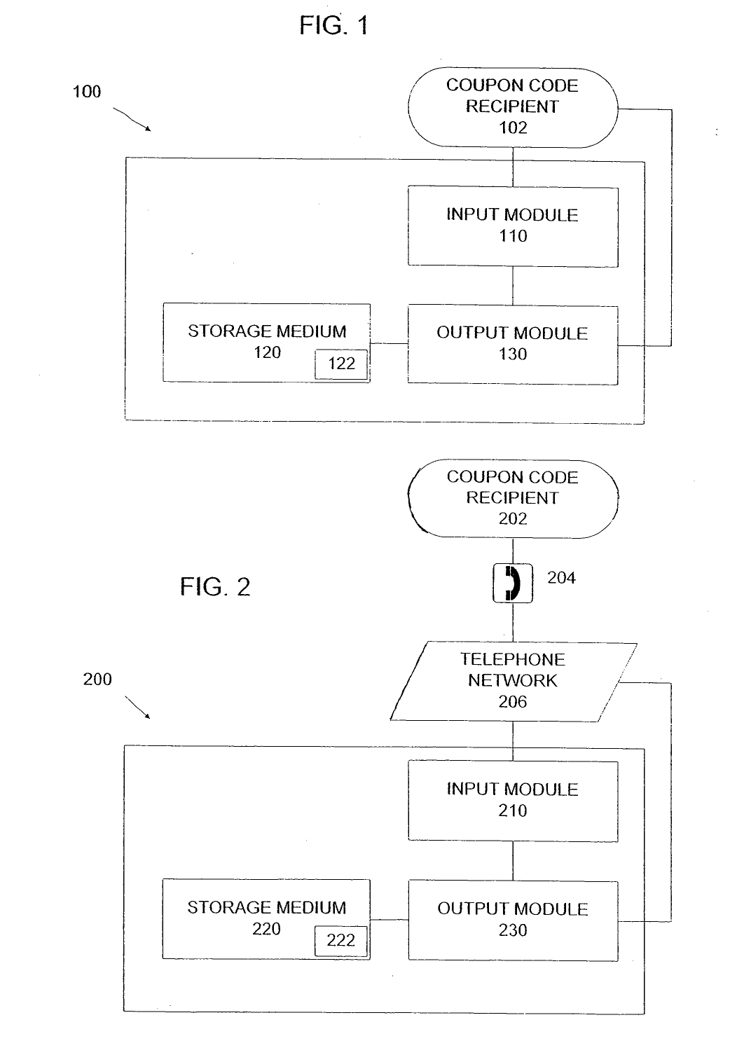

In some embodiments, the present invention generally provides systems and methods for generating, transmitting, and redeeming coupon codes. Turning now to the drawings, FIG. 1 illustrates an exemplary coupon code system 100 according to one embodiment of the present invention. Coupon code system 100 represents one of the many possible types of coupon code generation systems contemplated by the present invention. Coupon code system 100 includes an input module 110 for receiving a request from a recipient 102, a tangible storage medium 120 that stores a coupon code 122, and an output module 130 for transmitting coupon code 122 from tangible storage 120 toward recipient 102 in response to the request. Often, coupon code 122 is configured for delivery toward recipient 102 as an audio signal. In some instances, coupon code 122 is configured for delivery toward recipient as a data signal. Coupon code 122 may be delivered to recipient 102 via any of a variety of telephony or communication devices or modalities, such as a fixed line phone, a wireless phone, a facsimile, a teletypewriter (TTY), a telecommunication device for the deaf (TDD), an IP phone, a USB phone, a computer having sound card and speaker, a text message, a voice message (whether recorded or computerized) in English or another language, or a device capable of sending or receiving a text message. In many instances, coupon code 122 is transmitted toward coupon code recipient 102 as an audio signal, which may include an analog signal, a digital signal, or a combination thereof. A signal may be in audio, radio, electrical, or optical format, or a combination thereof. A signal may be embodied in one or more packets. In some instances, coupon code 122 may be transmitted as an audio signal that includes data encoded in an audio file format such as Advanced Audio Coding (AAC), MPEG-1 or MPEG-2 Audio Layer 3 (MP3), Waveform Audio (WAV), Windows Media Audio (WMA), and the like. It is also appreciated that input module 110, output module 130, or both, may include or be part of an interactive voice response (IVR) system.

FIG. 2 shows another exemplary coupon code system 200 according to one embodiment of the present invention. Coupon code system 200 includes an input module 210 for receiving a request from a recipient 202. Such a request can be transmitted from recipient 202 via a telephone 204 and a telephone network 206. Coupon code system 200 also includes a tangible storage medium 220 that stores a coupon code 222, and an output module 230 for transmitting coupon code 222 from tangible storage 220 toward recipient 202. Transmission of coupon code 222 from output module 230 toward recipient 202 can be via telephone network 206 and telephone 204. Often, coupon code 222 is configured for delivery toward recipient 202 as an audio signal.

Telephone 204 can include a standard fixed line telephone, or a mobile telephone such as a cellular telephone or a satellite telephone. Telephone network 206 may include or be part of a network of fixed line analog telephone systems. Similarly, telephone network 206 may include or be part of a network of digital telephone systems. In some embodiments, telephone network 206 may include or be part of a public switched telephone network (PSTN), a private branch exchange (PBX), or any other type of telephone exchange. Telephone network 206 can include a Digital Subscriber Line (DSL), an Integrated Services Digital Network (ISDN), a cable network, a PSTN/IP gateway, a computer terminal, the Internet, Voice over Internet Protocol (VoIP), or any other circuit, technology, or system that can transmit voice, speech, or other data. For example, telephone network 206 can include a home connection, a cell phone tower, a long distance exchange, or a transcontinental connection. In many instances, coupon code 222 is transmitted toward coupon code recipient 202 as an audio signal, which may include an analog signal, a digital signal, or a combination thereof.

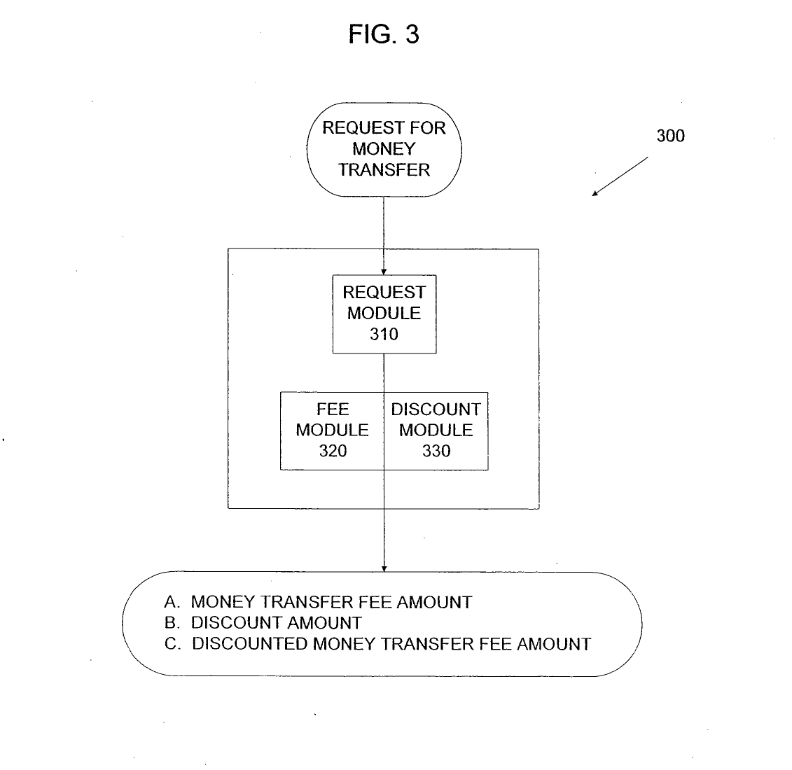

FIG. 3 illustrates one embodiment of a money transfer discounting system 300. Money transfer discounting system 300 represents one of the many possible types of coupon code redemption systems contemplated by the present invention. Money transfer system 300 includes a request module 310 for receiving a request to perform a money transfer. The request can include a money amount to be transferred, an identification of a particular transferee, a coupon code, or any other suitable transactional information. Money transfer system 300 also includes a fee module 320 for calculating a money transfer fee, and a discount module 330 for receiving a coupon code and adjusting the money transfer fee based on the coupon code. Money transfer discounting system 300 may be configured to carry out any desired discounting scheme based on the coupon code. In some instances, discount module 330 can apply a discount before fee module 320 calculates a money transfer fee. Similarly, in some instances fee module 320 can calculate a money transfer fee before discount module 330 applies a discount. In some embodiments, money transfer system 300 may be configured so that at least one of fee module 320 or discount module 330 are bypassed during a transaction, based on the coupon code.

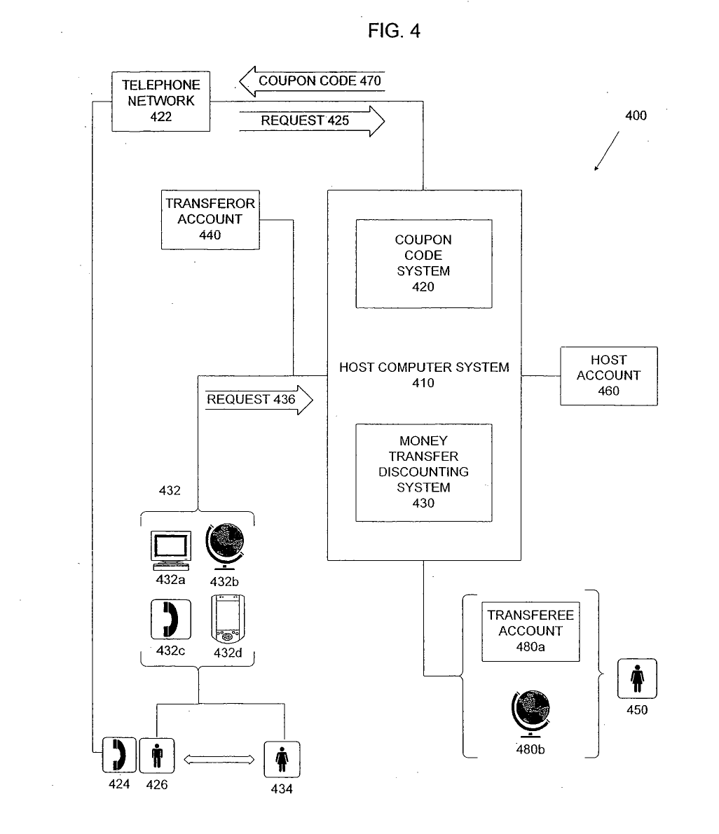

FIG. 4 illustrates a money transfer system 400 according to one embodiment of the present invention. Money transfer system 400 includes a host computer system 410, a coupon code system 420, and a money transfer discounting system 430. Host computer system 410, and optionally components of host computer system 410 including coupon code system 420 and money transfer discounting system 430, may include, for example, server computers, personal computers, workstations, web servers, or other suitable computing devices. Systems 410, 420, 430 may include application software that provide instructions for performing one or more functions according to the present invention. In some cases, systems 410, 420, and 430 may include a combination of computing devices and application software. It is appreciated that system 400 can be configured to carry out various methods of the present invention. For example, application software resident on host computer system 410 may program host computer system 410 to process money transfer requests and redemptions discussed elsewhere herein. Host computer system 410, coupon code system 420, and money transfer discounting system 430 may include one or more of the aforementioned computing devices, as well as storage devices such as databases, disk drives, optical drives, and the like. The storage devices may include solid state memory, such as RAM, ROM, PROM, and the like, magnetic memory, such as disc drives, tape storage, and the like, and optical memory, such as DVD, and the like. Host computer system 410 may be fully located within a single facility or distributed geographically, in which case a network may be used to integrate host computer system 410. The network may include the Internet, an intranet, a wide area network (WAN), a local area network (LAN), a virtual private network, any combination of the foregoing, or the like. The network may include both wired and wireless connections, including optical links. Many other examples are possible and apparent to those skilled in the art in light of this disclosure.

In some embodiments, host computer system 410 and other features of money transfer system 400 may be operated by a financial and communications provider such as Western Union Financial Services, Inc. Money transfers transacted via system 400 may be carried out in various ways. In one exemplary procedure, a recipient 426 can submit a coupon code request 425 to coupon code system 420 of host computer system 410. In some instances, coupon code request 425 can be submitted via a telephone 424 that communicates with coupon code system 420 via a telephone network 422. In response to request 425, coupon code system 420 transmits a coupon code 470 to recipient 426. This transmission can be effected via telephone network 422 and telephone 424. Having possession of coupon code 470, recipient 426 can use coupon code 470 to receive a discount on a transfer fee in a money transfer transaction. In some cases, recipient 426 acts as a transferor who transfers funds to transferee 450. In other cases, recipient 426 can give coupon code 470 to a third party 434, who can act as transferor and enjoy the benefit of coupon code 470.

To receive the discount, recipient 426 can submit a money transfer request 436 to money transfer discounting system 430 of host computer system 410. Money transfer request 436 can be submitted via any suitable transaction device 432, including for example an Internet enabled device 432a, an agent location 432b, a telephone 432c, or a point of sale (POS) device 432d. Transaction device 432 may be any of a number of devices capable of receiving a money transfer requests from a transferor. Internet enabled device 432a may include, without being limited to, a personal computer, a personal digital assistant (PDA), a mobile phone, and the like. Agent location 432b may include an office or other facility operated by a financial or communication service provider. For example, Western Union Financial Services, Inc. operates more than 235,000 agent locations in over 200 countries and territories around the world. When recipient 426 submits money transfer request 436 via telephone 432c, request 436 is often routed to a representative or other person who acts as an intermediary between recipient 426 and host computer system 410. For example, recipient 426 may initiate a request for a Western Union Money Transfer® transaction by calling 1-800-CALL-CASH®. Alternatively recipient 426 can transact money transfer request 436 with host computer system 410 via an interactive voice response (IVR) system or other computerized or automated communication modality. POS device 432d may include a standard fixed retail point of sale terminal, or it may include a portable point of sale terminal.

Exemplary POS devices are discussed in U.S. Pat. No. 6,547,132, the entire disclosure of which is incorporated herein by reference for all purposes. In general terms, POS devices are terminals for receiving transaction information and sending the information to a host computer system. For example, a POS may receive transaction information by capturing it from a card using a reader integral to or associated with the POS. A POS also may receive information from an attendant or transferor via a keypad, keyboard, and/or other input device. Other examples are possible. POS devices may be located at money transfer service provider locations. POS devices such as POS device 432d may be attended or unattended.

System 400, and in some cases transaction device 432, may include one or more transaction computing devices programmed to receive money transfer information from transferors or attendants. The transaction computing device may be any of the aforementioned computing devices. Like POS device 432d, the transaction computing devices may be located at money transfer service provider locations. At such locations, an attendant can enter the money transfer information and the transferor can complete an appropriate money transfer form. System 400 also may include one or more Customer Service Representative (CSR) computers. The CSR computers may be located, for example, at a call center operated by or for a money transfer service provider. The CSR computers may function much like POS device 432d or the aforementioned computing device, except that transaction information can be entered by a CSR who is receiving the information from a transferor by phone, for example. In some examples, a voice response unit may receive some or all of the information. System 400 may also include additional types of transaction devices 432, which may be embodied by one or more unmanned transaction devices such as a multi-purpose kiosk or an automated teller machine (ATM). ATMs are well known; kiosks are more fully described in U.S. patent application Ser. No. 10/225,410 filed Aug. 20, 2002 (Attorney Docket No. 020375-024800US), the entire disclosure of which is incorporated herein by reference for all purposes.

Money transfer request 436 is often accompanied by a payment, or a promise of payment. Customarily, this payment is made by transferor. Payment can be made with cash, or with a presentation instrument such as a credit card, a stored value card, a debit card, a frequent buyer card, and the like. Often, the presentation instrument can be associated with an account of the recipient 426. In some embodiments, a presentation instrument may include transaction data that can be read by a Near Field Communication reader. Exemplary presentation instruments are discussed in U.S. patent application Ser. No. 11/233,947 filed Sep. 22, 2005 (Attorney Docket No. 020375-068200US), the entire disclosure of which is hereby incorporated by reference for all purposes. Transaction device 432 may be configured to accept any of these payment types. In some cases, the transferor may initiate a money transfer request by providing a user name and password or other security information to transaction device 432. In some cases, transaction device 432 may prompt the transferor to input certain registration information via a personal information registration procedure so as to establish a user name and password for the transferor.

Money transfer request 436 will typically include an amount to be transferred, the identity of the transferee, a receiving agent location, a coupon code, or any other appropriate transactional information. Money transfer discounting system 430 receives money transfer request 436, and calculates a discounted money transfer fee based on coupon code 470. In some cases, the discount is based on a percentage of the transferred money. For example, if the transfer money amount is $100, and the coupon code provides a discount of 5% of the transferred amount, then the discount for the transfer fee is $5. Similarly, the discount may be based on a flat rate. For example, if the transfer money amount is $200, and the coupon code provides a discount of $5, then the transfer fee is discounted by $5. Relatedly, the discount may be based on the particular product or service being transacted. For example, the coupon code may provide a $5 discount on a money transfer fee when used in conjunction with a domestic money transfer, and may provide a $10 discount on a money transfer fee when used in conjunction with an international money transfer. Host computer system 410 may be configured to embody any of a variety of discounting schemes. For example, host computer system 410 may customize a coupon code for a particular recipient 426 or group of recipients based on past interaction between host computer system 410 and a particular person or group of persons or based on the recipient's name, address, Automatic Number Identification (ANI), loyalty code or number, registration number, personal identification number (PIN), or other identifier. An address may be a physical address such as a mailing address or post office address. An address may also be an electronic address, such as an email address, a text message address, and the like. In some cases, host computer system 410 may apply certain request rules to transactions involving recipient 426. Similarly, host computer system 410 may apply certain redemption rules to transactions involving transferor 426 or transferee 450. In some embodiments, host computer system 410 may be configured to approve or deny a money transfer request based on a funds availability or other status of transferor account 440.

The transferred money can be made available to transferee 450 via a transferee account 480a or an agent location 480b. It is further appreciated that the transferred money may be made available to transferee 450 via a device similar to transaction device 432 discussed above. For example, transferred money may be made available to transferee 450 via an unmanned transaction device such as a kiosk or ATM, as these devices are typically configured to dispense cash, money orders, and/or other forms of value, including local currency. In some embodiments, transferee 450 may provide a presentation instrument such as a bank card or a gift card, or a Near Field Communication enabled device such as a mobile telephone, such that transferee can effect acceptance of transferred funds into transferee account 480a. Transferred money may also be made available via a POS device. In some instances, transferee 450 may use POS device or other transaction device to redirect funds to an account or to another transferee.

In one illustrative example, recipient 426 wishes to transfer $100 to transferee 450. Recipient 426 submits a request to coupon code system 420 for coupon code 470. In this instance, coupon code 470 may be redeemed for a $5 discount to be applied against a money transfer fee. Upon receipt of coupon code 470, recipient 426 visits agent location 432b and submits a request to transfer $100. The standard transfer fee rate is 15% of the transferred amount, so in this case the standard transfer fee is $15. In sum, the total undiscounted amount to be charged to recipient is $115. Recipient 426 presents agent location with coupon code 470 to receive the discount of $5, which is subtracted from the $15 transfer fee. Thus, the discounted transfer fee is $10, and the total discounted cost to recipient is $110. All or part of the total discounted cost of $110 can be withdrawn from a transferor account 440, which may include a checking, savings, or credit account. Similarly, all or part of the total discounted cost of $110 may be paid directly to agent 432b via cash or other suitable legal tender. Of the total discounted cost of $110, the $100 money transfer can be routed to transferee account 480a or agent location 480b, and the $10 discounted transfer fee can be routed to host account 460.

Advantageously, coupon code request and redemption activity can generate large amounts of useful marketing data. Host computer system 410 may be configured to store, track, or otherwise analyze request activity or redemption activity. For example, host computer system 410 may collect data related to the date, location, product or service, name, address, ANI, loyalty code or number, registration number, PIN, and/or and coupon value associated with a coupon code request or coupon code redemption. Host computer system 410 may analyze such data to discern patterns or trends of coupon code request and redemption transactions. In some cases, such data, patterns, trends, or other information may be used to adjust or revise a coupon code value or a rule associated with a coupon code, or to devise or develop discounting schemes. Relatedly, host computer system 410 and other features of money transfer system 400 can be updated, revised, or otherwise customized or optimized by a financial and communications provider such as Western Union Financial Services, Inc. based on the results of such analysis.

In some embodiments, host computer system 410 may include fraud prevention of transferee authentication functionality as discussed in U.S. patent application Ser. No. 10/832,809 Apr. 26, 2004 (Attorney Docket No. 022352-008110US). The host computer system can be designed to limit the number of coupons codes distributed to a single recipient over a fixed period of time (e.g., day, week, month) based on the recipient's name, postal address, e-mail or text message address, ANI, loyalty code or number, registration number, PIN, or other identifier. In some embodiments, host computer system may include currency exchange functionality as discussed in U.S. patent application Ser. No. 10/206,661 filed Jul. 26, 2002 (Attorney Docket No. 022352-003020US). The entire contents of each of these applications are incorporated by reference for all purposes.

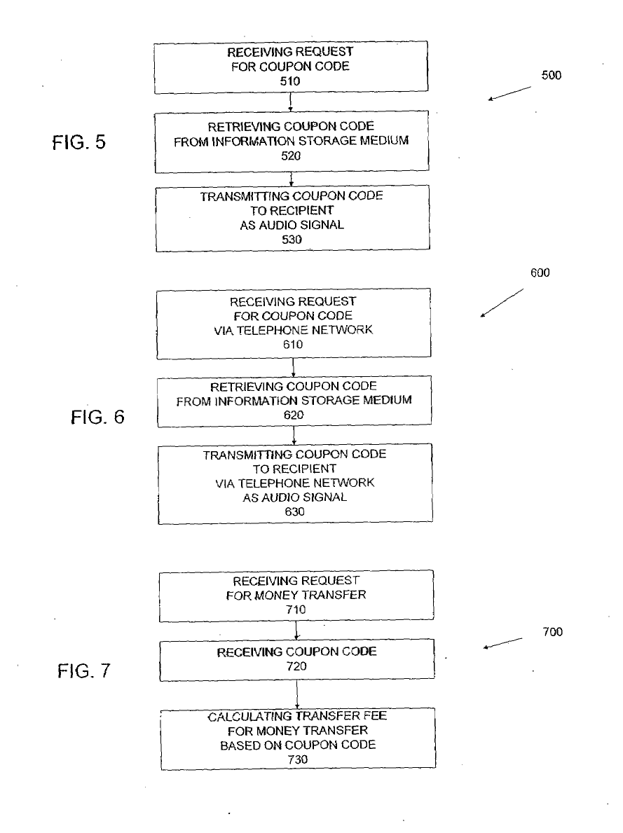

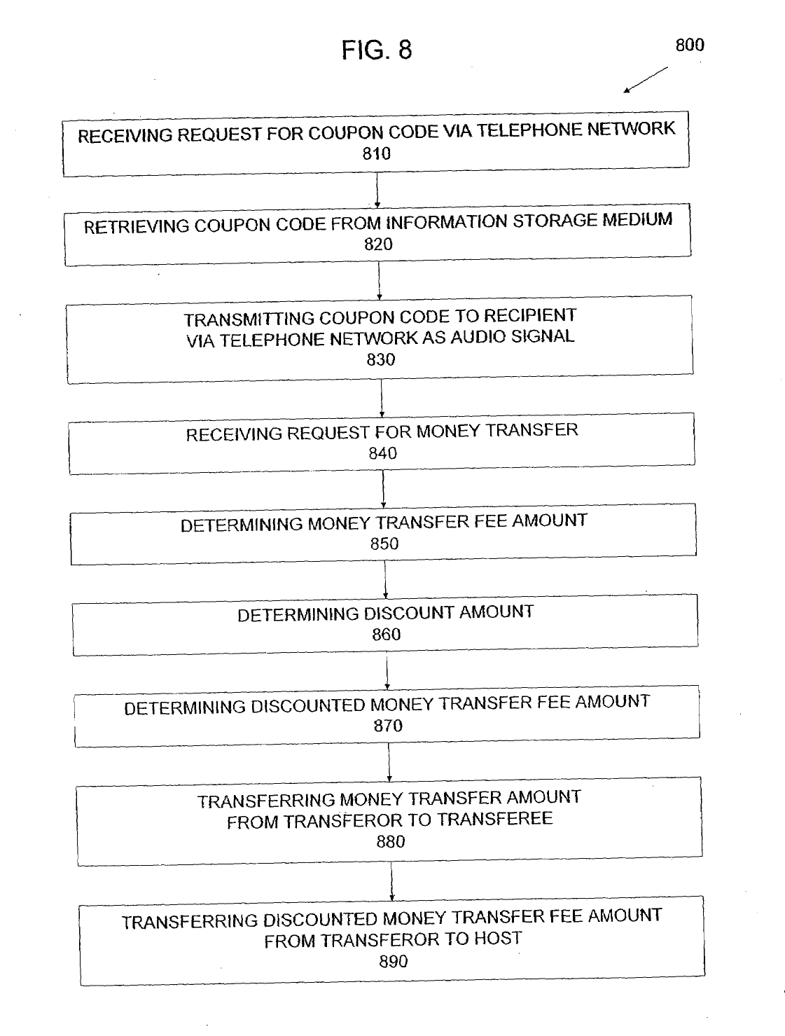

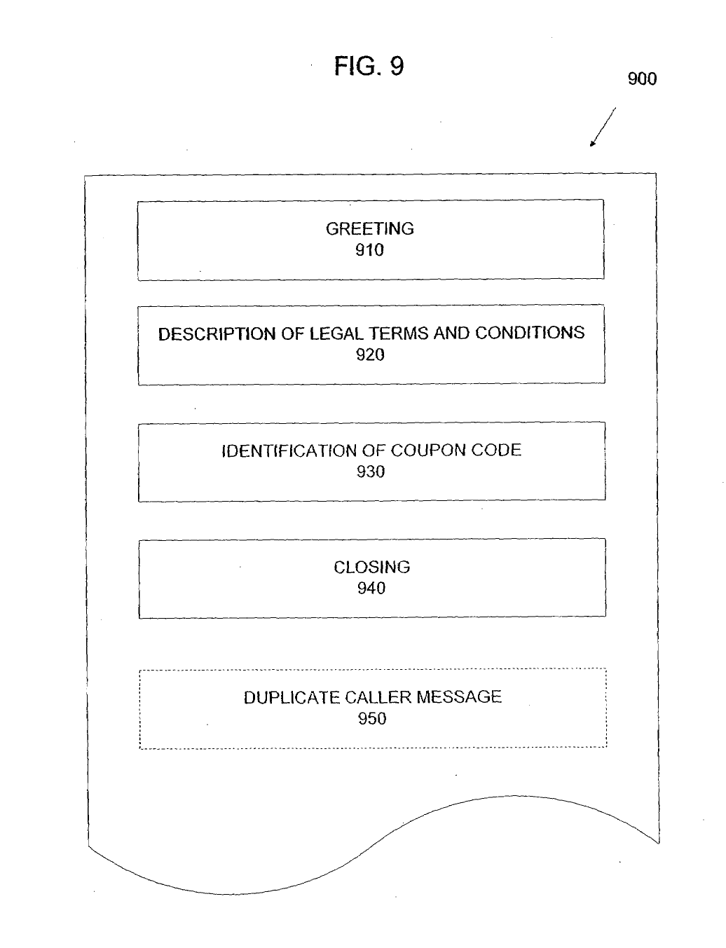

FIG. 5 illustrates a method 500 of providing a coupon code to a recipient according to one embodiment of the present invention. Step 510 of the method includes receiving a request for a coupon code. Step 520 includes retrieving the coupon code from an information storage medium, and step 530 includes transmitting the coupon code to a recipient as an audio signal. FIG. 6 illustrates a method 600 of providing a coupon code to a recipient according to one embodiment of the present invention. Step 610 of the method includes receiving a request for a coupon code via a telephone network or other network. Step 620 includes retrieving the coupon code from an information storage medium, and step 630 includes transmitting the coupon code to the recipient as an audio signal via a telephone network or other network. FIG. 7 illustrates a method 700 for providing a discount on a money transfer fee according to one embodiment of the present invention. Step 710 of method 700 includes receiving a request for a money transfer. Step 720 includes receiving a coupon code. Step 730 includes calculating a transfer fee for the money transfer. The calculation includes adjusting or determining the transfer fee based on the coupon code. Methods, such as those illustrated in FIGS. 5, 6, and 7, as well as FIGS. 8 and 9, provide method steps according to various embodiments of the present invention. Such illustrated methods can be carried out by a system that includes a processor and a memory coupled to the processor. The memory may be configured to store a plurality of modules which have the instructions and algorithms for carrying out the steps of the method.

FIG. 8 illustrates a method 800 for transferring money according to one embodiment of the present invention. Step 810 of the method includes receiving a request for a coupon code via a telephone network or other network. Step 820 includes retrieving the coupon code from an information storage medium, and step 830 includes transmitting the coupon code to the recipient as an audio signal via a telephone network or other network. Step 840 includes receiving a request for a money transfer. Typically the request includes or is associated with the coupon code. Step 850 includes determining a transfer fee for the money transfer. Step 860 includes determining a discount amount, which will typically be based on the coupon code. Step 870 includes determining a discounted money transfer fee amount. Step 880 includes transferring a money transfer amount from a transferor to a transferee, and step 890 includes transferring the discounted money transfer fee amount from the transferor to a host account. In some methods, the transferor is provided with a receipt confirming details of the transaction.

In some embodiments, method 800 is well suited for implementation by financial and communication service providers such as Western Union Financial Services, Inc., who may administer method 800 via a host computer system as depicted in FIG. 4. It is appreciated that various aspects of method 800 may be revised by such providers according to their particular needs or objectives. In one embodiment, the provider may wish to limit the number of coupons made available to any one recipient or group of recipients. For example, the provider may wish to limit each coupon recipient to one coupon per day. Such allowances or restrictions, which may more generally be referred to as rules, can be effected in various ways. For example, a coupon code system of the host computer system may be configured to recognize coupon code requests as originating from a particular recipient (based on the recipient's name, address, ANI, loyalty code or number, registration number, PIN, or other identifier), and the coupon code system may limit the number of coupons made available to that particular recipient per a given time period. Alternatively, a money transfer discounting system of the host computer system may be configured to recognize coupon code redemption requests as originating from a particular transferor, and the money transfer discounting system may limit the number of coupon redemptions made available to that particular transferor per a given time period. In this sense, various implementations of the methods, techniques, and rules disclosed herein may be effected in connection with a coupon code request via a coupon code system configuration. Alternatively, these implementations may be effected connection with a coupon code redemption via a money transfer discounting system configuration.

The present invention contemplates the implementation of any of variety of coupon code request and redemption rules. In some embodiments, a coupon code can include a redemption limit identifier that limits the number of times the coupon code may be redeemed. The redemption limit identifier may be set so that a coupon code may be redeemed only once, or alternatively the redemption limit identifier may indicate that the coupon code may be redeemed a multiple number of times or even an unlimited number of times. In some cases, a provider may wish to place restrictions on how a coupon code may be used. For example, a coupon code may include a redemption location identifier that designates a redemption location at which the coupon code may be redeemed. If a redemption location identifier designates use with an Internet enabled transaction device, then a transferor may only use coupon in association with a money transfer request that is submitted via an Internet enabled transaction device. If a redemption location identifier designates use with a telephone money transfer, then a transferor may only use coupon in association with a money transfer request that is initiated over the telephone. Similarly, a redemption location identifier may designate use with an agent location, a POS, or any other desired transaction device or combination of transaction devices. In other related cases, a coupon code may include a redemption expiration date that indicates a date beyond which the coupon code is irredeemable. The redemption expiration date may be based on a selected calendar date. In some instances, the redemption expiration date may be calculated based on date the coupon code request was made. For example, a coupon code may remain redeemable for a five day period starting from the date the coupon code was requested. In some embodiments, a coupon code may include a validation identifier to indicate the validity of the coupon. Similarly, a money transfer discounting system may be configured to recognize such a validation identifier, or to otherwise confirm or determine the validity of a coupon code. In at least some embodiments, redemption of a coupon may be restricted to a money transfer amount that is equal to or greater than a certain minimum value, or that is equal to or less than a certain maximum value, or that has a value within a certain value range.

In some instances, a value of the coupon code, or a rule according to which the coupon code may be redeemed, can be based on an Automatic Number Identification (ANI) associated with the coupon code recipient's request. For example, a coupon code may correspond to a discount based on an ANI associated with the recipient's request. Similarly, the coupon code may correspond to a discount based on a usage log compiled for an ANI associated with the recipient's request. In some embodiments, systems and method according to the present invention may provide the coupon code recipient with instructions for using the coupon code, such that the instructions are based on an ANI associated with the recipient's request. An ANI is just one example of a data that can be associated with recipient during a coupon code request transaction. In another example, a coupon code system may prompt the recipient to enter or input certain information, such as name, address, ANI, loyalty code or number, registration number, PIN, or other identifier. Loyalty codes can be allocated to customers, and service providers may maintain loyalty records corresponding to such loyalty codes based on requests, redemptions, and other interactions transacted between the customer and the provider. In some embodiments, points may be allocated to a customer's loyalty record, and coupon codes can be customized for the customer based on their loyalty record. It is appreciated that a name, address, ANI, loyalty code or number, registration number, PIN, identifier, and other type of information or data associated with a recipient can be used by coupon code system to determine a value of the coupon code, or a rule according to which it may be redeemed. In some cases, coupon code values and coupon code rules may be assigned to be associated with a particular recipient, or in some cases with a selected group of recipients.

FIG. 9 illustrates a promotional script 900 for a coupon code system according to one embodiment of the present invention. Promotional script 900 includes a greeting 910, a description of legal terms and conditions 920, a prompt to accept or repeat the legal terms and conditions, an identification of a coupon code 930, a closing 940, and optionally, a duplicate caller message 950. Promotional script 900 is typically transmitted from a coupon code system to a coupon code recipient. Script 900 can be transmitted as an audio signal, via a telephone network. In some cases, script 900 is transmitted from a Customer Service Representative to the recipient. Similarly, in some cases script 900 is transmitted to the recipient via an interactive voice response system.

In one illustrative example, Table 1 provides the message text for a sample promotional script. In some embodiments, the script may be presented to a recipient in response to a “1-800” (or other toll-free or toll-based) phone call from the recipient to a coupon code system.

TABLE 1
Promotional Script

| | |
|---|---|
| Greeting | Thank you for calling Western Union ®. To receive your coupon code for |
| | $5 off select money transfers within the U.S. you must first listen to and |
| | accept the following terms and conditions. |
| Legal Terms and | Take up to $5 off your next U.S. person to person In Minutes ® money |
| Conditions | transfer, payable same day at any participating U.S. Agent location. This |
| | offer excludes all other Western Union ® services. If the amount of the |
| | transfer fee is less than $5, no cash, credit or refund will be provided. |
| | Limit one coupon per transaction. The coupon code may only be used |
| | once, and has no cash redemption value. The coupon code cannot be |
| | combined with any other offer. The consumer must pay any applicable |
| | taxes on undiscounted transfer fees. Void where prohibited. Void if |
| | transferred, sold or bartered. |
| Prompt | Press 1 to accept terms and conditions and receive your coupon code or |
| | Press 2 to repeat the terms and conditions. The coupon code is a 15 |
| | character code, so please make sure you have a pen handy to write down |
| | each character, including dashes. |
| Coupon Code | Thank You. Your coupon code is 123CODE-456. The coupon code |
| | expires Dec. 31, 2020. When providing your coupon code, make |
| | sure to include the dash. |
| Closing | If you would like to hear your coupon code again, press 1. You can take |
| | your coupon code to a Western Union Agent Location, go to |
| | westernuion.com, or call 1-800-CALL-CASH to redeem it on your next |
| | In Minutes ® money transfer within the U.S. If you would like more |
| | information, such how to find a nearby Agent location, Press 2. Thank |
| | you for calling Western Union ®. The fastest way to send money |
| | worldwide. |
| Duplicate Caller | I'm sorry, our records show that you have reached today's limit of one |
| Message | coupon code per day. Please call back tomorrow to receive another |
| | coupon. |

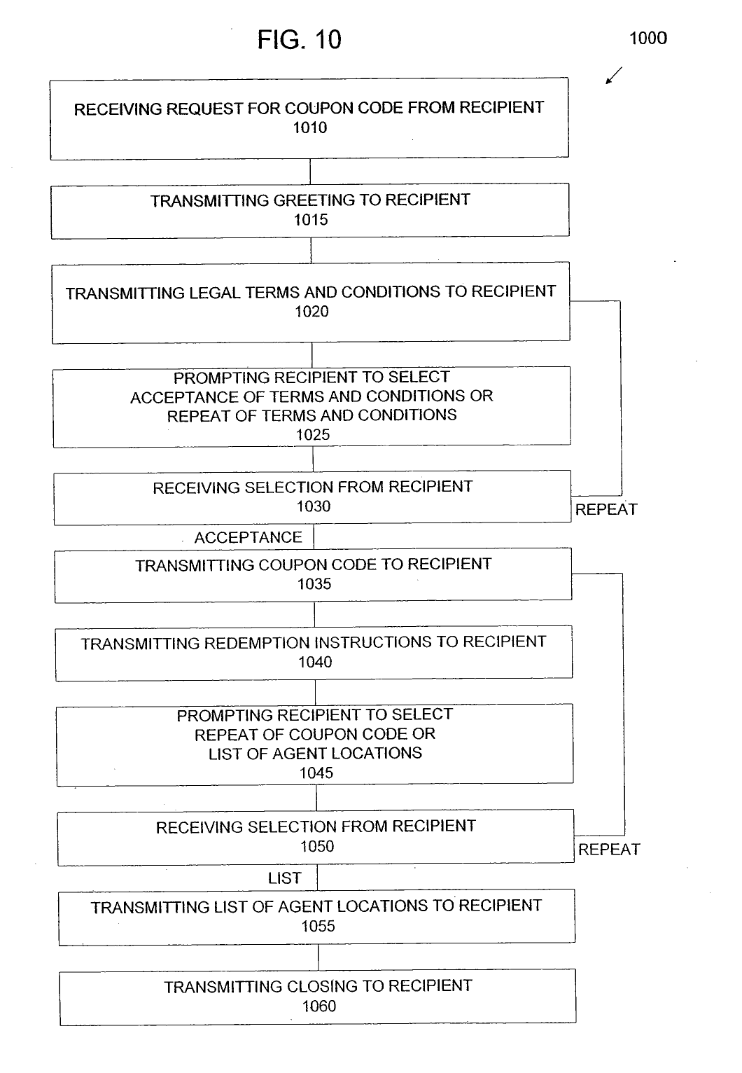

FIG. 10 illustrates a method 1000 for processing a request for a coupon code based on a script similar to the script provided in Table 1. In some cases, method 1000 can be transacted via a coupon code system. Step 1010 includes receiving a request for a coupon code from a recipient. Step 1015 includes transmitting a greeting to the recipient, step 1020 includes transmitting legal terms and conditions to the recipient, and step 1025 includes prompting the recipient to select an acceptance of the terms and conditions, or a repeat of the terms and conditions. Step 1030 includes receiving the selection from the recipient. If the recipient selects “repeat” the method can return to step 1020. If the recipient selects “acceptance” the method can advance to step 1035, which includes transmitting the coupon code to the recipient. Step 1040 includes transmitting coupon code redemption instructions to the recipient, and step 1045 includes prompting the recipient to select a repeat of the coupon code, or a list of agent locations. Step 1050 includes receiving the selection from the recipient. If the recipient selects “repeat” the method can return to step 1035. If the recipient selects “list” the method can advance to step 1055, which includes transmitting a list of agent locations to the recipient. Step 1060 includes transmitting a closing to the recipient.

In addition to the steps described above in method 1000, the present invention contemplates scripted methods for processing a request for a coupon code that can include various types of messages, prompts, inputs, and the like. For example, some methods may include transmitting offers or advertisements for products or services to the recipient. Related methods may include prompting a coupon code recipient to input or otherwise provide certain personal or demographic information such as residence address, age, income, marital status, number of children, hobbies, name, ANI, loyalty code or number, registration number, PIN, identifier, and the like. In some embodiments, a coupon code value or a rule for the coupon code may be assigned based on the quality or quantity of information provided by the recipient, or on the number or frequency of coupon code requests submitted by the recipient.

In addition to money transfer transactions, a coupon code may be configured for use with other types of products or services including, without limitation to, airline tickets, hotel reservations, vehicle rentals, concert tickets, amusement park tickets, and the like. Relatedly, a coupon code can include a product-specific or service-specific identifier, whereby the coupon code may only be redeemed in association with a specific product or service.

The coupon code systems and methods discussed herein may be used in conjunction with any of a variety of money transfer techniques such as those described in U.S. patent application Ser. No. 10/091,000 filed Mar. 4, 2002 (Attorney Docket No. 022352-008700US), Ser. No. 10/206,661 filed Jul. 26, 2002 (Attorney Docket No. 022352-003020US), Ser. No. 10/687,575 filed Oct. 15, 2003 (Attorney Docket No. 022352-038910US), Ser. No. 10/806,484 filed Mar. 22, 2004 (Attorney Docket No. 022352-050900US), Ser. No. 10/832,809 Apr. 26, 2004 (Attorney Docket No. 022352-00811US), and Ser. No. 10/987,201 filed Nov. 12, 2004 (Attorney Docket No. 020375-054900US), and in U.S. Pat. Nos. 6,488,203, 6,502,747, and 6,761,309, the contents of each of which are hereby incorporated herein by reference for all purposes.

Although certain system, device, and method embodiments have been disclosed herein, it will be apparent from the foregoing disclosure to those skilled in the art that variations, modifications, alternative constructions, and equivalents of such embodiments may be made without departing from the true spirit and scope of the invention. Therefore, the above description should not be taken as limiting the scope of the invention which is defined by the appended claims.

What is claimed is:

1. A method for providing a coupon code to a recipient via a network, comprising:
storing a coupon code on a tangible storage medium of a host computer;
receiving a request for the coupon code from the recipient; and
providing the recipient with the coupon code via the network in response to the request;
wherein the coupon code is transmitted along the network between the host computer and the recipient as an analog , a digital signal, or a combination analog and digital signal.

2. The method according to claim 1, wherein the network comprises a telephone network.

3. The method according to claim 1, wherein the coupon code corresponds to a benefit comprising a member selected from the group consisting of a discount for a money transfer fee, a discount on a purchase of a product or service, a premium item, and an entry into a contest or sweepstakes.

4. The method according to claim 1, wherein the coupon code comprises a member selected from the group consisting of a redemption limit identifier that limits the number of times the coupon code may be used, a redemption location identifier that designates a redemption location at which the coupon code may be redeemed, and a redemption expiration date that indicates a date beyond which the coupon code is irredeemable.

5. The method according to claim 1, wherein the coupon code corresponds to a benefit based on an identifier associated with the recipient's request, the identifier comprising a member selected from the group consisting of a name, an address, an Automatic Number Identification (ANI), a loyalty code or number, a registration number, and a personal identification number (PIN).

6. The method according to claim 1, wherein the coupon code corresponds to a benefit based on a usage log compiled for the identifier associated with the recipient's request.

7. The method according to claim 1, further comprising providing the recipient with instructions for redeeming the coupon code, wherein the instructions are based on an identifier associated with the recipient's request, the identifier comprising a member selected from the group consisting of a name, an address, an Automatic Number Identification (ANI), a loyalty code or number, a registration number, and a personal identification number (PIN).

8. The method according to claim 1, wherein the coupon code corresponds to a benefit based on an identifier provided by the recipient, the identifier comprising a member selected from the group consisting of a name, an address, an Automatic Number Identification (ANI), a loyalty code or number, a registration number, and a personal identification number (PIN).

9. A system for providing a coupon code to a recipient via a telephone network, comprising:
a tangible storage medium that stores a coupon code;
an input module that receives a request for the coupon code from the recipient; and
an output module that transmits the coupon code from the tangible storage medium to a network in response to the recipient request, such that the coupon code is configured for delivery along the network toward the recipient as an analog signal, a digital signal, or a combination analog and digital signal.

10. The system according to claim 9, wherein the output module comprises an interactive voice response system.

11. The system according to claim 9, wherein the coupon code corresponds to a benefit comprising a member selected from the group consisting of a discount for a money transfer fee, a discount on a purchase of a product or service, a premium item, and an entry into a contest or sweepstakes.

12. The system according to claim 9, wherein the coupon code comprises a member selected from the group consisting of a redemption limit identifier that limits the number of times the coupon code may be used, a redemption location identifier that designates a redemption location at which the coupon code may be redeemed, and a redemption expiration date that indicates a date beyond which the coupon code is irredeemable.

13. The system according to claim 9, wherein the coupon code corresponds to a benefit based on an identifier associated with the recipient's request, the identifier comprising a member selected from the group consisting of a name, an address, an Automatic Number Identification (ANI), a loyalty code or number, a registration number, and a personal identification number (PIN).

14. A system for providing a discount on a money transfer fee, comprising:
a request module that receives a request to perform a money transfer;
a fee module that calculates a money transfer fee for the money transfer; and
a discount module that discounts the money transfer fee based on the coupon code.

15. The system according to claim 14, wherein the coupon code comprises a member selected from the group consisting of a redemption limit identifier that limits the number of times the coupon code may be used, a redemption location identifier that designates a redemption location at which the coupon code may be redeemed, and a redemption expiration date that indicates a date beyond which the coupon code is irredeemable.

16. The system according to claim 14, wherein the coupon code corresponds to a discount based on an identifier associated with the recipient's request, the identifier comprising a member selected from the group consisting of a name, an address, an Automatic Number Identification (ANI), a loyalty code or number, a registration number, and a personal identification number (PIN).

17. A method for providing a discount on a money transfer fee, comprising:
providing a coupon code to a customer via a network;
receiving a request to perform a money transfer;
receiving the coupon code;
calculating a money transfer fee for the money transfer; and
discounting the money transfer fee based on the coupon code.

18. The method according to claim 17, wherein the coupon code comprises a member selected from the group consisting of a redemption limit identifier that limits the number of times the coupon code may be used, a redemption location identifier that designates a redemption location at which the coupon code may be redeemed, and a redemption expiration date that indicates a date beyond which the coupon code is irredeemable.

19. A system for transferring money, comprising:
a coupon code generation system configured to receive a coupon code request and transmit a coupon code to a recipient as an analog signal, a digital signal, or a combination analog and digital signal in response to the coupon code request; and
a coupon code redemption system configured to receive a money transfer request from a transferor and discount a money transfer fee based on the coupon code.

20. The system according to claim 19, wherein the coupon code comprises a member selected from the group consisting of a redemption limit identifier that limits the number of times the coupon code may be used, a redemption location identifier that designates a redemption location at which the coupon code may be redeemed, and a redemption expiration date that indicates a date beyond which the coupon code is irredeemable.
